(19) United States
(12) Patent Application Publication
(10) Pub. No.: US 2003/0213771 A1
(43) Pub. Date: Nov. 20, 2003

(54) Surface treatment method for magnesium alloys and magnesium alloy members thus treated

(76) Inventors: Kenichirou Ohshita, Kanagawa-Pref (JP); Masahiro Motozawa, Kanagawa-Pref (JP)

Correspondence Address: HENKEL CORPORATION, 2500 RENAISSANCE BLVD, STE 200, GULPH MILLS, PA, 19406, US

(21) Appl. No.: 10/240,434

(22) PCT Filed: Mar. 29, 2001
(86) PCT No.: PCT/US01/10031

(30) Foreign Application Priority Data
Mar. 31, 2000 (JP) 200099399

(51) Int. Cl. C23F 1/00; B44C 1/22; C03C 15/00; C03C 25/68

(52) U.S. Cl. 216/83

(57) ABSTRACT

The present invention provides a surface treatment method for magnesium alloys that can form a uniform, fine, and dense conversion coating on a magnesium alloy surface on which mold release agent, an oxide layer, and an alloying component (e.g., aluminum and zinc) segregation layer are potentially present, and also provides magnesium alloy member whose surface has been treated by the aforesaid surface treatment method. The surface treatment method of the present invention comprises a degreasing process to degrease the surface of the magnesium alloy, a chemically etching process to chemically etch the alloy, and a conversion treatment process to form a conversion coating. The chemical etching forms a magnesium phosphate coating having a coating weight of 10 to 2,000 mg/m², measured as phosphorus, by bringing the surface of the magnesium alloy into contact with an aqueous solution containing a phosphoric acid-type compound.

### BACKGROUND OF THE INVENTION

1. Field of the Invention

This invention relates to a novel surface treatment method that can be used to impart excellent corrosion resistance and paint adherence to the surface of magnesium alloys. This invention also relates to magnesium alloy members treated by the surface treatment method.

2. Background Art

Many of the metal members (e.g., aluminum alloys, steel, magnesium alloys) used to make automobiles, two-wheel vehicles, and consumer electronics must exhibit corrosion resistance and have an attractive appearance. As a consequence, the metal members subject to these requirements are subjected to, prior to their end use, to any of a variety of surface treatments, typically followed by painting. At least some of the purposes of the surface treatment is to remove contaminants, e.g., cutting oil, that may remain on the substrate surface and to form a relatively fine, dense conversion coating on the surface to thereby provide increased corrosion resistance and paint adherence.

With the issues of global environmental protection providing impetus, an active effort has recently been underway to utilize magnesium alloys, which are the lightest of the widely used metals and have excellent recycling capabilities. For example, in the automotive sector, magnesium alloys have begun to be used in components heretofore made of other metals, such as steel or aluminum alloy; the goal of this utilization is to reduce vehicle weight in order to improve fuel efficiency. In the area of consumer electronics, movement is underway to convert from the heretofore used plastics to the highly recyclable magnesium alloys—the focus here is on the casing and enclosures for notebook computers and portable telephones. The majority of these magnesium alloy members are formed by casting methods known as die casting and thixomolding. In these casting methods, the magnesium alloy, in a molten or semimolten condition, is introduced into the mold or die at high speeds and pressures. As a result, these casting methods provide excellent dimensional accuracy and productivity. Depending on the particular product, forming can also be carried out by forging or press forming using wrought grades of magnesium alloy sheets.

The magnesium alloy members under consideration, like aluminum alloys and steels, are first subjected to surface treatment and are then painted. Since magnesium alloys, which are the most active of the widely used metals, are readily susceptible to corrosion, the formation of a uniform, fine, and dense conversion coating in the surface treatment process is even more critical for magnesium alloys than for aluminum alloys and steels. This notwithstanding, it is extremely difficult to form a uniform, fine, and dense conversion coating on magnesium alloys, due to the chemical heterogeneity of magnesium alloy surfaces.

The chemical heterogeneity of magnesium alloy surfaces will therefore be considered here in greater detail. The magnesium alloys used for automobiles, two-wheel vehicles, and consumer electronics generally contain large amounts of alloying component, e.g., aluminum and zinc or manganese, in order to improve such properties as formability and mechanical strength or ductility. For example, AZ91, which is the magnesium alloy most generally used for casting, contains 9% aluminum and 1% zinc as alloying components. In the case of surface treatment processes in which chemical reactions are employed to form conversion coatings, the behavior of these alloying components in the substrate frequently has a major influence on the capacity for surface treatment. While it is considered desirable for these alloying components to assume a microfine and uniform distribution in the material in order to bring about the formation of a fine and dense conversion coating, the alloying components (e.g., aluminum, zinc) in magnesium members formed by die casting or thixomolding frequently do not assume a uniform distribution in the material and undergo segregation.

This segregation in magnesium alloys will be considered here in additional detail. Segregation generally refers to the phenomena in which the impurities and/or alloying components in a metal assume a nonuniform distribution. The occurrence of segregation during alloy solidification is the most frequent case. For example, with regard to regions in contact with the die from the outset during die casting or thixomolding, the purity tends to be higher where solidification occurs from the beginning (vicinity of the overflow), while the impurity and alloying component concentration tends to be higher in those regions that subsequently solidify (gate vicinity). With regard to the central zones of thick sections of the product, the alloying components can segregate in these zones in very high concentrations since solidification occurs here last; but in addition, due to the pressurization during post-injection solidification in die casting and thixomolding, liquid phase in which alloying components have segregated in high concentrations can slip between solid phases and ultimately infiltrate out to the surface due to capillary phenomena. These types of segregation are called macrosegregation.

When, on the other hand, the metallographic structure of magnesium alloy is considered, one finds that the alloy is constituted of an a-phase (alpha-phase) composed of high-purity magnesium and a b-phase (beta-phase) of intermetallic compounds containing alloying components, for example, Mg17A112. This b-phase frequently segregates at the grain boundaries rather than assuming a uniform distribution in the material. This type of segregation is called microsegregation.

Macrosegregations exhibit a variety of behaviors depending on such factors as the cooling rate and pressurization conditions during casting. The same is true of microsegregations. As a consequence, even for the same alloy composition, the degree of segregation and the metallographic structure will vary as a function of the shape and region of the member and the casting conditions. This in turn makes the surface chemically heterogeneous and strongly impairs the ability to form a fine, dense, and uniform conversion coating.

Methods for the surface treatment of magnesium alloys have typically used one of the following three treatment sequences.

| | |
|---|---|
| (Treatment sequence 1) | degreasing → water rinse → conversion |
| | treatment → water rinse → pure water rinse → |
| | drying |
| (Treatment sequence 2) | degreasing → water rinse → chemical |
| | etching → water rinse → conversion |
| | etching → water rinse → pure water rinse → |
| | drying |
| (Treatment sequence 3) | degreasing → water rinse → chemical |
| | etching → water rinse → desmutting → water |
| | rinse → conversion treatment → water rinse → |
| | pure water rinse → drying |

The main purpose of the degreasing process employed in each of these treatment sequences is the removal of light organic contaminants such as machine oils and cutting oils. The main purpose of the chemical etching process is to dissolve and remove the surfacemost layers, which include, in addition to the light organic contaminants (machine oils, cutting oils), mold release agent, an alloy segregation layer, and a layer of hydroxide. The main purpose of the desmutting process is to remove the smut, i.e., erosion products produced by etching, left on the surface by the chemical etching process and to remove residual surface-concentrated alloying components without etching. The main purpose of the conversion treatment process has is to form a conversion coating on the surface. This conversion coating can be, for example, a chromic acid chromate system or a manganese phosphate system, and mainly functions to improve the corrosion resistance and paint film adherence.

The selection of a particular treatment sequence is made based on such factors as the performance required of the surface treatment and the extent of surface contamination. For example, treatment sequence 2 or 3 is used for a member carrying a relatively large amount of mold release agent, while treatment sequence 1 is used when the member is only relatively weakly loaded with mold release agent.

Numerous inventions and much information have appeared to date with respect to the surface treatment methods under discussion. The conversion treatment baths can themselves be broadly classified into treatment baths that contain hexavalent chromium (chromate types) and treatment baths that do not contain hexavalent chromium (nonchromate types). Within the sphere of hexavalent chromium-containing treatment baths, those developed by Dow Chemical (United States) are widely known and have achieved commercialization. These include, for example, a chromic acid treatment bath (the Dow 1 method), a dichromic acid treatment bath (the Dow 7 method), an alkaline dichromic acid treatment bath (the Dow 9 method), and a manganese chromate treatment bath (the Dow 22 method). These treatment baths are relatively uninfluenced by surface variations and provide excellent corrosion resistance and paint film adherence.

However, the hexavalent chromium present in these treatment baths can be harmful to humans and the appearance of a hexavalent chromium-free treatment bath is sometimes desired. The appearance may also sometimes be desired of a surface treatment method that could use such a bath to provide surfaces with even higher levels of corrosion resistance and paint film adherence, and that could do so with even less influence from surface variations.

Numerous inventions have also appeared within the sphere of conversion treatment baths that do not contain hexavalent chromium, and some examples are provided in the following. Japanese Published (Kokoku or Examined) Patent Application Number Hei 5-58073 (58,073/1993), entitled “Anticorrosion treatment method for members made of magnesium alloy”, teaches the formation of a corrosion-resistant protective coating by the application to a member of an erosive bath containing at least 1 selection from nitric acid, sulfuric acid, and phosphoric acid. Japanese Laid Open (Kokai or Unexamined) Patent Application Number Hei 9-228062 (228,062/1997), entitled “Method for treating metal surfaces”, teaches the use of at least 1 organometal compound selected from metal alkoxides, metal acetylacetonates, and metal carboxylates and at least 1 film-forming assistant selected from acids, bases, and salts thereof and organic compounds that contain the hydroxyl, carboxyl, or amino group. Japanese Laid Open (Kokai or Unexamined) Patent Application Number Hei 9-241861 (241,861/1997), entitled “Method for treating the surface of magnesium alloy components and magnesium alloy components whose surface has been treated by said method”, teaches the formation of a poorly soluble salt of magnesium and organic acid on magnesium surfaces by the reaction of the surface of a magnesium alloy member with the aqueous solution of an organic acid or the soluble salt of an organic acid. Japanese Laid Open (Kokai or Unexamined) Patent Application Number Hei 9-24338 (24,338/1997), entitled “Method for forming highly corrosion-resistant paint films on magnesium alloys”, teaches treatment with an aqueous solution containing zinc ion, manganese ion, phosphate ion, a fluorine compound, a film-forming assistant, nickel ion, cobalt ion, and copper ion, each in specified concentrations. Japanese Laid Open (Kokai or Unexamined) Patent Application Number Hei 8-35073 (35,073/1996), entitled “Method for modifying the surface of magnesium base metal moldings”, teaches treatment of magnesium base metal moldings with an aqueous solution that contains at least 1 water-soluble salt of permanganic acid or manganic acid. However, all of these conversion treatment baths are strongly influenced by variations in the substrate and none provide a stable performance.

Inventions have also appeared on the degreaser used in the degreasing process and the etchant used in the chemical etching process. For example, Japanese Laid Open (Kokai or Unexamined) Patent Application Number Sho 53-102231 (102,231/1978), entitled “Acid rinse bath for magnesium and magnesium alloys”, teaches the addition of at least 1 selection from sulfuric acid, hydrochloric acid, nitric acid, and oxalic acid to an aqueous solution containing a specified amount of persulfate salt. Japanese Laid Open (Kokai or Unexamined) Patent Application Number Hei 6-220663 (220,663/1994), entitled “Method for removing smut from magnesium alloy surfaces”, teaches a desmutting treatment that removes the smut remaining on the surface after the magnesium alloy has been subjected to an acid rinse. This desmutting treatment is carried out using an alkaline aqueous solution containing a specified amount of ethylenediaminetetraacetic acid.

The object of the foregoing inventions is to remove the mold release agent, oxide film, and alloy segregation layer by etching the magnesium alloy surface. This notwithstanding, it is still difficult using these methods to produce a fine, dense, and uniform conversion treatment on magnesium surfaces and thus it remains difficult to obtain an excellent corrosion resistance and excellent paint film adherence using these methods.

### SUMMARY OF THE INVENTION

The present invention is therefore directed to solving the problems identified above in the prior art. More specifically, an object of the present invention is to provide a surface treatment method for magnesium alloys wherein the method has the ability to form fine, dense, and uniform conversion coatings on magnesium alloy surfaces that carry mold release agent, an oxide layer, and a segregation layer of alloying components (e.g., aluminum, zinc) and on this basis has the ability to impart excellent corrosion resistance and paint film adherence. An additional object of the present invention is to provide magnesium alloy members that have been surface treated by the inventive surface treatment method.

It has been unexpectedly discovered that these problems in the prior art can be solved and a fine, dense, and uniform conversion coating can be formed on magnesium alloy surfaces by first contacting the magnesium alloy surface in a chemical etching process with an aqueous solution containing a phosphoric acid-type compound and thereafter executing a conversion treatment on the magnesium alloy surface. This chemical etching process results in the formation of a magnesium phosphate coating at the same time that it dissolves and removes the mold release agent, oxide layer, and segregation layer of alloying components. The present invention is based on this discovery.

More specifically, the method for treating the surface of magnesium alloys comprises degreasing a surface of the magnesium alloy, chemically etching the surface of the magnesium alloy, and forming a conversion coating on the surface of the magnesium alloy, wherein the chemical etching step comprises subjecting the surface of the magnesium alloy to an aqueous solution containing a phosphoric acid-type compound to form a magnesium phosphate coating on the surface of the magnesium alloy having a coating weight of 10 to 2,000 mg/m², measured as phosphorus.

After forming or molding by a casting process (e.g., die casting or thixomolding), press working, or forging, the surface of the resulting magnesium alloy member will generally be chemically heterogeneous. This heterogeneity is caused, for example, by the presence on the surface of mold release agent coated on the die during casting, by the segregation at the surface of alloying components (e.g., aluminum and zinc or manganese), and by the growth on the surface of a thick oxide film due to reaction with atmospheric oxygen. This chemical heterogeneity generally makes it quite difficult to form a fine, dense, and uniform conversion coating. The surface treatment method of the present invention is particularly effective for inducing the formation on such surfaces of a fine, dense, and uniform conversion coating and as a consequence for inducing the appearance of an excellent corrosion resistance and excellent paint film adherence by such surfaces.

The phosphoric acid-type compound in the phosphoric acid-type compound-containing aqueous solution used in the aforesaid chemical etching process preferably includes at least 1 component selected from the group consisting of orthophosphoric acid, phosphonic acids, pyrophosphoric acid, tripolyphosphoric acid, and the alkali metal salts of the preceding acids. This aqueous solution preferably has a phosphoric acid-type compound concentration in the range of 1 to 200 g/L and a pH in the range of 1 to 12.

The conversion treatment bath in the subject conversion treatment process is preferably an acidic aqueous solution with a pH of 2 to 6 that at least contains orthophosphoric acid and at least 1 metal ion selected from the group consisting of Zn, Mn, and Ca, or is preferably an acidic aqueous solution with a pH of 2 to 6 that contains an oxoacid compound of at least 1 metal selected from the group consisting of Mn, Mo, W, Ta, Re, Nb, and V and at least 1 fluorine compound selected from the group consisting of hydrofluoric acid, fluosilicic acid, fluozirconic acid, and fluotitanic acid.

Magnesium alloy members according to this invention characteristically comprise magnesium alloy members whose surface has been treated by the hereinabove-described inventive method for treating magnesium alloy surfaces.

### DETAILED DESCRIPTION OF THE PREFERRED EMBODIMENT(S)

The method for treating magnesium alloy surfaces of the present invention (in some cases referred to below simply as the surface treatment method) will be explained in more detail below.

The surface treatment method of this invention is applied to magnesium alloy members. The type of magnesium alloy is not critical, and the magnesium alloy can include, but are not necessarily limited to, casting alloys such as AZ91, AM60, ZK51, or ZK61, or wrought alloys such as AZ31, AZ61, or ZK60. Any type of forming technique may be used to form the magnesium alloy member. Suitable techniques include, but are not necessarily limited to, die casting, thixomolding, press molding, and forging.

The method for treating magnesium alloy surfaces of the present invention is based on the above-described treatment sequence 2, i.e., degreasing →water rinse→chemical etching→water rinse→conversion treatment→water rinse→pure water rinse→drying. However, the degreasing, chemical etching, and conversion treatment processes are the critical processes in the method of the present invention, around which the other processes should be suitably configured as necessary or desired. In addition, when the surface of the magnesium alloy workpiece is relatively heavily loaded with mold release agent or the oxide film layer has grown relatively thick, the following treatment sequence 4 is particularly preferred for obtaining stable coating properties.

Treatment Sequence 4:

degreasing→water rinse→etching (acidic aqueous solution)→water rinse→desmutting→water rinse→chemical etching→water rinse→conversion treatment→water rinse→pure water rinse→drying

The etching process (acidic aqueous solution) present in treatment sequence 4 is different from the above-mentioned chemical etching referred to in connection with the present invention in that the former is a simple etch with an acidic aqueous solution. The former will be referred to herein as “etching process (acidic aqueous solution)” to distinguish it from the aforementioned chemical etching.

The various processes will be further described below in the preferred order of execution.

The Degreasing Process

The surface of the magnesium alloy should be degreased prior to the chemical etching process; this degreasing helps to provide the formation of a fine, dense, and uniform magnesium phosphate coating in the ensuing chemical etching process.

The degreasing treatment in the degreasing process is carried out by bringing the magnesium alloy workpiece into contact with a degreasing bath. Methods for contacting the magnesium alloy workpiece with the degreasing bath can be, for example, a dipping or spraying method as known in the art. Either method can be used in this invention, and the concept of contact in each of the processes described below should be similarly construed.

The composition of the degreasing bath used in the degreasing process is not critical as long as the bath can remove organic contaminants. However, preferably, an aqueous alkaline solution containing surfactant is employed in the degreasing bath. The alkali builder in such a degreasing bath can be, for example, an alkali metal hydroxide, phosphate, silicate, or carbonate.

The surfactant can be a nonionic, cationic, or anionic surfactant. A chelating agent may be added in order to improve the degreasing efficiency.

The temperature and time interval of contact between the degreasing bath and the magnesium alloy are not critical. Contact in the range of 35 to 70° C. for 2 to 10 minutes is preferred as a function of the extent of contamination of the magnesium alloy surface. The concentration of the degreasing bath should be selected as appropriate taking into consideration such factors as the extent of contamination of the magnesium alloy surface and the components in the degreasing bath.

When the surface of the magnesium alloy workpiece is relatively heavily contaminated with mold release agent and/or when the oxide film layer has grown to a relatively large thickness, the surface of the magnesium alloy can be shotblasted followed by degreasing as a substitute for treatment sequence 4 given above. Shotblasting can physically remove the contaminants remaining on the magnesium alloy surface.

Degreasing with a degreasing bath can optionally be omitted when shotblasting is applied. However, degreasing with a degreasing bath is preferably carried out even when shotblasting has been done since the shotblasted magnesium alloy surface will still carry material abraded off by shotblasting and oily material contained therein. For purposes of this invention, the concept of degreasing also includes a shotblasting treatment. As a consequence, the degreasing process designated as an essential process in the present invention includes the following 3 variants: treatment by shotblasting alone, treatment only by degreasing with a degreasing bath, and degreasing with a degreasing bath after a shotblasting treatment.

The Etching Process (Acidic Aqueous Solution)

As already noted above, an etching process (acidic aqueous solution) is desirably carried out prior to the chemical etch (see below) when the surface of the magnesium alloy workpiece is relatively heavily loaded with mold release agent or when the oxide film layer has grown relatively thick. This etching process (acidic aqueous solution) can chemically remove the contaminants remaining on the magnesium alloy surface and can produce a completely clean surface.

The etching treatment in this etching process (acidic aqueous solution) is conducted by effecting contact between an acidic aqueous solution and the magnesium alloy workpiece.

The nature of the acidic aqueous solution is not critical as long as it can effectively dissolve and remove the contaminants on the magnesium alloy surface; however, the use of sulfuric acid, nitric acid, hydrochloric acid, tartaric acid, or oxalic acid is preferred. Conditions such as the concentration and temperature of the acidic aqueous solution and the time of contact with the magnesium alloy surface are again not critical and should be selected as appropriate considering such factors as the extent of contamination of the magnesium alloy surface and the components of the acidic aqueous solution.

The Desmutting Process

It is desirable when an etching treatment has been run by the above-described etching process (acidic aqueous solution) to follow the etching treatment with a desmutting process in order to remove the smut remaining on the magnesium alloy surface.

Desmutting in this desmutting process is carried out by contacting the magnesium alloy workpiece with a desmutting bath.

The nature of this desmutting bath is not critical as long as it can effectively remove the smut remaining on the magnesium alloy surface. The desmutting bath, for example, can be an aqueous sodium hydroxide solution adjusted to a pH of at least 12 or can be a strongly alkaline aqueous solution containing a chelating component. Representative examples of the latter type are disclosed in Japanese Laid Open (Kokai or Unexamined) Patent Application Number 6-220663 (220,663/1994), entitled “Method for removing smut from magnesium alloy surfaces”.

Conditions such as the concentration and temperature of the desmutting bath and the contact time with the magnesium alloy surface are not critical and should be selected as appropriate considering such factors as the amount of smut bound on the magnesium alloy surface and the components in the desmutting bath.

The Chemical Etching Process

In the chemical etching process, the magnesium alloy workpiece is brought into contact with an aqueous solution containing a phosphoric acid-type compound. This induces the formation of a magnesium phosphate film while at the same time cleaning the surface of the magnesium alloy. Thus, treatment by the chemical etching process according to the present invention differs from those treatments with an acidic aqueous solution generally labeled as etching in that the former is also intended to result in coating formation.

Treatment by the subject chemical etching process produces a magnesium phosphate coating while at the same time dissolving and removing the mold release agent, oxide layer, and alloying component segregation layer that remain on the magnesium alloy surface. The deposition weight of the magnesium phosphate coating that is formed on the magnesium alloy surface must be from 10 to 2,000 mg/m², measured as phosphorus, and is more preferably from 50 to 1,000 mg/m², measured as phosphorus.

The substrate cannot be satisfactorily covered by the magnesium phosphate coating having a magnesium phosphate coating deposition weight below 10 mg/m², measured as phosphorus, which creates the potential for a diminished corrosion resistance and an impaired paint film adherence. At the other end of the range, the coating becomes coarse if the coating has a magnesium phosphate deposition weight at above 2,000 mg/m², measured as phosphorus, which can again cause a diminished corrosion resistance and an impaired paint film adherence.

Since, as described above, the surface of magnesium alloys is chemically heterogeneous, the magnesium phosphate coating will more readily form in the chemically active regions of the magnesium alloy surface. More specifically, this coating will more readily form in regions where the aluminum and zinc alloying components have segregated in relatively high concentrations and in regions that lack a relatively thick oxide coating.

The phosphoric acid-type compound present in the subject phosphoric acid-type compound-containing aqueous solution (abbreviated below as the PAC-containing aqueous solution) preferably comprises at least 1 selected from the group consisting of orthophosphoric acid, phosphonic acids, pyrophosphoric acid, tripolyphosphoric acid, and the alkali metal salts of the preceding acids.

The concentration of the PAC-containing aqueous solution will vary with the type of phosphoric acid-type compound, but the concentration of the phosphoric acid-type compound will preferably be from 1 to 200 g/L. It is essentially impossible to obtain the specified phosphorus deposition when the concentration of the phosphoric acid-type compound is below 1 g/L, while the coating can become coarse when this concentration exceeds 200 g/L.

The subject PAC-containing aqueous solution preferably has a pH in the range from 1 to 12. A pH below 1 can produce an excessive etch and a coarse coating. A pH in the strongly alkaline region (range above pH 12) produces a deficient etch and will not generate the specified phosphorus deposition and hence will not produce a good corrosion resistance or paint film adherence. Moreover, at the same time that the chemical etching process induces the formation of a magnesium phosphate coating on the magnesium alloy surface, it additionally functions, by etching the surface, to dissolve and remove mold release agent, the oxide layer, and the segregation layer of alloying components. As a consequence, the weak capacity of a strongly alkaline treatment bath to etch magnesium alloy surfaces also prevents a thorough dissolution and removal of the mold release agent, oxide layer, and alloying component segregation layer and in this sense can again be a factor that negatively influences the corrosion resistance and paint film adherence.

The subject PAC-containing aqueous solution preferably has a pH in the range of 1 to 10 and more preferably in the range of 1 to 7. The pH of the PAC-containing aqueous solution is directly determined by the particular phosphoric acid-type compound selected and by its concentration. However, small adjustments in the pH can be obtained by the suitable addition of a base component for adjustment to the alkaline side or an acid component for adjustment to the acid side. The base component can be exemplified by sodium hydroxide, sodium carbonate, tertiary sodium phosphate, and ammonia, while the acid component can be exemplified by phosphoric acid, nitric acid, sulfuric acid, tartaric acid, and oxalic acid.

The temperature and time of contact between the PAC-containing aqueous solution and the magnesium alloy workpiece will vary as a function of the species of magnesium alloy workpiece and the nature, concentration, and pH of the PAC-containing aqueous solution itself; however, in all cases the contact temperature and contact time should be selected so as to produce the phosphorus deposition specified above.

The Conversion Treatment Process

Once the surface of the magnesium alloy workpiece has been both cleaned and coated with a magnesium phosphate coating in the chemical etching process, it is submitted to a conversion treatment process and subjected to a conversion treatment. The surface of the magnesium alloy workpiece is ordinarily thoroughly rinsed with water between the chemical etching process and the conversion treatment process. The conversion treatment is carried out by bringing the magnesium alloy workpiece into contact with a conversion treatment bath.

There are no particular restrictions on the conversion treatment bath used here, and the conversion treatment baths known in the art for application to magnesium or magnesium alloy—including so-called chromate system conversion treatment baths—can be used for the present purposes. Of course, chromate system conversion treatment baths contain environmentally suspect hexavalent chromium, and conversion treatment baths free of hexavalent chromium are preferred.

The conversion treatment bath used in this process is preferably selected from the two types (1) and (2) described hereafter.

(1) Acidic aqueous solutions that have a pH of 2 to 6 and that contain at least orthophosphoric acid and at least 1 metal ion selected from the group consisting of Zn, Mn, and Ca.

The orthophosphoric acid concentration in the type (1) conversion treatment bath is preferably in the range of 10 to 100 g/L and more preferably is in the range of 30 to 70 g/L. The metal ion concentration in the type (1) conversion treatment bath is preferably in the range of 1 to 10 g/L and more preferably is in the range of 3 to 7 g/L.

The desired conversion coating deposition weight in the case of conversion treatment with a type (1) conversion treatment bath will depend on the species of metal ion, but is preferably in the range of 30 to 300 mg/m² measured as the metal ion and more preferably is in the range of 50 to 200 mg/m² measured, as the metal ion.

(2) Acidic aqueous solutions that have a pH of 2 to 6 and that contain an oxoacid compound of at least 1 metal selected from the group consisting of Mn, Mo, W, Ta, Re, Nb, and V and at least one fluorine compound selected from the group consisting of hydrofluoric acid, fluosilicic acid, fluozirconic acid, and fluotitanic acid.

The fluorine compound concentration in a type (2) conversion treatment bath is preferably in the range of 20 to 1,000 mg/L and more preferably is in the range of 50 to 500 mg/L. The concentration of the metal oxoacid compound is preferably in the range of 0.5 to 10 g/L and more preferably is in the range of 1 to 7 g/L.

The desired conversion coating deposition weight in the case of conversion treatment with a type (2) conversion treatment bath will depend on the species of metal ion, but is preferably in the range of 10 to 300 mg/m², measured as the metal ion and more preferably is in the range of 30 to 200 mg/m², measured as the metal ion.

The temperature of the conversion treatment bath in the conversion treatment process and the time of contact between the conversion treatment bath and the magnesium alloy workpiece should be selected as appropriate taking into consideration such factors as the composition and concentration of the conversion treatment bath, the surface condition of the magnesium alloy workpiece, and the desired conversion coating deposition weight.

The magnesium phosphate coating formed on the magnesium alloy surface in the chemical etching process has a low chemical activity, and as a consequence almost no conversion coating forms on this magnesium phosphate coating during the conversion treatment process. Formation of the conversion coating does occur, however, in those regions either not covered or not thoroughly covered by the magnesium phosphate coating.

In addition, the low chemical activity of the magnesium phosphate coating formed by the chemical etching process causes this coating to itself act like a conversion coating to improve the corrosion resistance and paint film adherence. This—and the conversion treatment in the ensuing conversion treatment process of those regions not thoroughly covered by the magnesium phosphate coating in the chemical etching process—enable the formation of a fine, dense, and uniform conversion coating (i.e., a composite coating) on the chemically heterogeneous surface of magnesium alloys. The overall result is the generation of an excellent corrosion resistance and an excellent paint film adherence.

The Various Water Rinse Processes

A water rinse process is preferably placed between each of the foregoing processes in order to prevent perturbations (e.g., deterioration of a treatment bath due to introduction therein of another treatment bath) caused by carry over of the treatment bath in an upstream process (degreasing bath, acidic aqueous solution, desmutting bath, PAC-containing aqueous solution, or conversion treatment bath) into an ensuing process. The water rinse in each water rinse process is effected by bringing the magnesium alloy workpiece into contact with water.

There are no specific restrictions on the extent of the water rinse (e.g., contact time, water purity and temperature, number of stages in the water rinse, degree of dilution), and the water rinse conditions should be selected as appropriate considering such factors as the concentration of the particular treatment bath and the amount of influence upon admixture into a downstream bath.

The Pure Water Rinse Process

Surface treatment in accordance with this invention is finished once the magnesium alloy has passed through the conversion treatment process. However, if conversion treatment bath were to remain on the surface, its concentration during drying could lead to corrosion of the surface of the magnesium alloy or corrosion of the coating formed on the surface. In addition, the application of paint to a surface still carrying small amounts of contaminants can result in the appearance of defects such as lumps, crawling, and pinholes in the painted surface. Finally, when the painting operation is carried out by immersion, impurities still present on the surface may be introduced into the paint bath with resulting degradation of the paint itself.

It is for these reasons that the execution of a pure water rinse is desirable in order to replace conversion treatment bath remaining on the surface with pure water that is either free of impurities or contains only small amounts of impurities.

The pure water used in this pure water rinse need not be pure water as such, and deionized water of the quality used as pure water in the paint industry will be sufficient for the present purposes.

The Drying Process

After the magnesium alloy has passed through the various processes described above (or has passed through a subset of these processes depending on the circumstances), it is desirably dried in order to evaporate off the moisture remaining on the surface. Of course, when painting with a water-based paint, drying is not essential since, in this case, painting is possible even with moisture remaining on the surface. However, even in the case of painting with a water-based paint, a drying process is still desirably implemented since the introduction of moisture into the paint can alter the concentration of the paint.

The drying process itself is not critical, and drying can be carried out, for example, by spontaneous drying. However, drying in an oven is preferred using a convection heater or infrared heater.

A magnesium alloy member in accordance with the present invention is obtained by employing the surface treatment magnesium alloy surfaces of the present inventive as described hereinabove.

The resulting magnesium alloy member according to the present invention will exhibit an excellent corrosion resistance without further processing, but may as desired be painted in order to obtain additional improvements in the corrosion resistance or additional improvements in the aesthetics of the magnesium alloy member.

There are no particular restrictions on the type of paint used in the painting operation, and either water-based or solvent-based paints may be used. Nor are there any particular restrictions on the painting method, and any painting method known in the art can be used, for example, spray painting, dipping, electrodeposition, and so forth.

### EXAMPLES

Working examples of the inventive surface treatment method are provided below, and the efficacy of the working examples is illustrated by comparison with comparative examples also provided below. This invention is not, however, limited to the working examples that follow. Small adjustments in the pH of the treatment baths were made by the addition of suitable amounts of sodium hydroxide for adjustment to the alkaline side and phosphoric acid for adjustment to the acid side (excluding Comparative Example 6).

The Test Materials

The following three types of magnesium alloy sheet were used as the test materials:

AZ91D (ASTM designation, die cast, 100 mm×100 mm×1 mm)

AM60B (ASTM designation, die cast, 100 mm×100 mm×1 mm)

AZ31C (ASTM designation, rolled sheet, 100 mm×100 mm×1 mm)

(0064)

Measurement of Coating Deposition

1. The Magnesium Phosphate Coatings

The coating deposition weight of the magnesium phosphate coatings formed by the chemical etching process was determined by measurement of the phosphorus deposition in the coating. The measurements were carried out using a commercial fluorescent x-ray diffraction instrument. Multiple samples having different known amounts of phosphorus deposition were measured in advance and the resulting intensity values (cps) were used to construct an intensity-versus-deposition amount working curve. The samples produced in the working and comparative examples were measured under the same conditions, and the measured intensity values were converted to deposition amount using the working curve.

The measurement samples were produced in the following working and comparative examples by treatment by the chemical etching process followed, without execution thereon of conversion treatment, by rinsing with water, drying, and cutting to the measurement size.

2. The Conversion Coatings

Since two types of conversion treatment baths as described below were used (a manganese system and a zirconium system), the coating deposition amount was determined by measurement of the manganese deposition or zirconium deposition in the coating. Using a commercial fluorescent x-ray diffraction instrument, the measured intensity was converted to amount of deposition using a working curve that had been preliminarily prepared as described above for measurement of the amount of phosphorus deposition.

The measurement samples were produced in the following working and comparative examples by execution of the conversion treatment in the conversion treatment process followed by rinsing with water, drying, and cutting to the measurement size. Since manganese was also present as an alloying component in some of the test material, the manganese deposition was in such cases obtained by subtracting the value measured prior to the conversion treatment from the value measured after conversion treatment (the pre-conversion treatment measurement value was determined at the same time as measurement of the phosphorus deposition, supra).

### Example 1

AZ91D was used as the test material and was submitted to surface treatment using the treatment sequence described below and treatment bath compositions and treatment conditions in each process as described below.

Treatment Sequence:

degreasing (alkaline degreasing)→water rinse→chemical etching→water rinse→conversion→water rinse→pure water rinse→drying

Treatment Bath Compositions and Treatment Conditions in Each Process

the degreasing process (alkaline degreasing): FINECLEANER (registered trademark) MG101 from Nihon Parkerizing Co., Ltd., 30 g/L, 60° C., 5 minutes, dipping

the chemical etching process: orthophosphoric acid, 30 g/L (adjusted to pH 2.5), 25° C., 2 minutes, dipping, phosphorus deposition: 200 mg/m²

the conversion treatment process: MAGBOND (registered trademark) P20, a manganese system from Nihon Parkerizing Co., Ltd., 200 g/L, 43° C., 3 minutes, dipping, manganese deposition: 75 mg/m²

the water rinses between each process: tapwater, 25° C., 30 seconds, dipping

pure water rinse: deionized water (electrical conductivity=2 μS), flow spread over entire surface

drying: convection oven drying for 10 minutes at 120° C.

### Example 2

Surface treatment was carried out as in Example 1, with the exception that the treatment bath composition and treatment conditions in the chemical etching process were changed as described below from those in Example 1.

the chemical etching process: sodium orthophosphate, 30 g/L (adjusted to pH 9.5), 60° C., 5 minutes, dipping, phosphorus deposition: 130 mg/m²

### Example 3

Surface treatment was carried out as in Example 1, with the exception that the treatment bath composition and treatment conditions in the chemical etching process were changed as described below from those in Example 1.

the chemical etching process: orthophosphoric acid, 30 g/L (adjusted to pH 2.5), 25° C., 6 minutes, dipping, phosphorus deposition: 500 mg/m²

### Example 4

Surface treatment was carried out as in Example 1, with the exception that the treatment bath composition and treatment conditions in the chemical etching process were changed as described below from those in Example 1.

the chemical etching process: orthophosphoric acid, 100 gL (adjusted to pH 2.5), 25° C., 6 minutes, dipping, phosphorus deposition: 1500 mg/m ²

### Example 5

Surface treatment was carried out as in Example 1, with the exception that the treatment bath composition and treatment conditions in the chemical etching process were changed as described below from those in Example 1.

the chemical etching process: orthophosphoric acid, 30 g/L (adjusted to pH 2.5), 25° C., 15 seconds, dipping, phosphorus deposition: 12 mg/m²

### Example 6

Surface treatment was carried out as in Example 1, with the exception that the treatment bath composition and treatment conditions in the conversion treatment process were changed as described below from those in Example 1.

the conversion treatment process: MAGBOND (registered trademark) M30, a zirconium system from Nihon Parkerizing Co., Ltd., 50 g/L, 60° C., 1 minute, dipping, zirconium deposition: 50 mg/m²

### Example 7

Surface treatment was carried out as in Example 1 with the following changes: the test material was changed to AM60B; the phosphorus deposition in the chemical etching process was adjusted to 180 mg/m²; and the manganese deposition in the conversion treatment process was adjusted to 70 mg/m².

### Example 8

Surface treatment was carried out as in Example 1 with the following changes: the test material was changed to AZ31C; the phosphorus deposition in the chemical etching process was adjusted to 110 mg/m²; and the manganese deposition in the conversion treatment process was adjusted to 30 mg/m².

### Comparative Example 1

Surface treatment was carried out as in Example 1, but in this case omitting the chemical etching process from the treatment sequence described for Example 1.

### Comparative Example 2

Surface treatment was carried out as in Example 7, but in this case omitting the chemical etching process from the treatment sequence described for Example 7.

### Comparative Example 3

Surface treatment was carried out as in Example 8, but in this case omitting the chemical etching process from the treatment sequence described for Example 8.

### Comparative Example 4

Surface treatment was carried out as in Example 6, but in this case omitting the chemical etching process from the treatment sequence described for Example 6.

### Comparative Example 5

Surface treatment was carried out as in Example 1, with the exception that the treatment bath composition and treatment conditions in the chemical etching process were changed as described below from those in Example 1.

the chemical etching process: orthophosphoric acid, 30 g/L (adjusted to pH 2.5), 25° C., 10 seconds, dipping, phosphorus deposition: 5 mg/m²

### Comparative Example 6

Surface treatment was carried out as in Example 1, with the exception that the chemical etching process described in Example 1 was changed to an etching process (acidic aqueous solution) using the treatment bath composition and treatment conditions described below.

the etching process (acidic aqueous solution): sulfuric acid, 20 g/L (adjusted to pH 2.5 with sodium hydroxide), 25° C., 30 seconds, dipping (the phosphorus deposition was of course 0 mg/m²)

Evaluation Testing

The following evaluation tests were run on the surface-treated magnesium alloy members prepared in the working and comparative examples. The test results are reported in Table 1 below. Results in the evaluation tests that are acceptable from a practical standpoint are indicated by a score of “+” or better.

1. Post-Surface Treatment Corrosion Resistance

Each surface-treated magnesium alloy member (the sample) was subjected to corrosion resistance testing directly without additional processing. The salt-spray method stipulated in JIS Z-2371 was used for the evaluation; the salt-spray exposure time was 72 hours. After completion of salt-spray exposure, the post-surface treatment corrosion resistance was evaluated by visual inspection of the status of rust development on the sample. The results were scored using the following scale.

| | |
|---|---|
| + + | rust area less than 1% |
| + | rust area at least 1% but less than 3% |
| • | rust area at least 3% but less than 5% |
| x | rust area greater than or equal to 5% |

2. Post-Painting Corrosion Resistance

The sample for evaluation of the post-painting corrosion resistance was prepared by application to 20 to 25 μm of a cationic electrodeposition paint (Elecron 2000 from Kansai Paint Co., Ltd.) on the surface of the surface-treated magnesium alloy member and drying for 20 minutes at 180° C. The salt-spray method stipulated in JIS Z-2371 was used for testing. A cross was scribed in the paint film on the sample prior to testing. The salt-spray exposure time was 720 hours. Upon completion of salt-spray exposure, the post-painting corrosion resistance was evaluated by measuring the single-side blister width from the cross cut in the sample. The results were scored using the following scale.

| | |
|---|---|
| + + | single-side blister width from the cross cut less than 1 mm |
| + | single-side blister width from the cross cut at least 1 mm but |
| | less than 3 mm |
| • | single-side blister width from the cross cut at least 3 mm but |
| | less than 5 mm |
| x | single-side blister width from the cross cut equal to or greater |
| | than 5 mm |

3. Paint Film Adherence

The sample for evaluation of paint film adherence was prepared by painting the surface-treated magnesium alloy member as described above under 2. Post-painting corrosion resistance. The paint film adherence was evaluated based on the number of remaining paint squares in testing by the crosshatch grid/tape peel method for testing paint film adherence (JIS K-5400, 1 mm×1 mm, 100 squares). The evaluation was carried out both initially and after water resistance testing for 1,000 hours at 40° C. The results were scored using the following scale.

| | |
|---|---|
| + + | no paint film peeling (number of remaining paint squares = |
| | 100/100) |
| + | number of remaining paint squares less than 100/100 but at least |
| | 98/100 |
| • | number of remaining paint squares less than 98/100 but at least |
| | 95/100 |
| x | number of remaining paint squares less than 95/100 |

TABLE 1
Evaluation results

| | | | | | | paint | |
|---|---|---|---|---|---|---|---|
| | | | | | | film adherence | |
| | | | | corrosion resistance | | after water | |
| | test | P deposition | conversion | post- | post- | | resistance |
| | material | mg/m² | treatment | conversion | painting | initial | testing |
| Example 1 | AZ91D | 200 | manganese | + + | + + | + + | + + |
| Example 2 | AZ91D | 130 | manganese | + + | + + | + + | + + |
| Example 3 | AZ91D | 500 | manganese | + + | + + | + + | + + |
| Example 4 | AZ91D | 1500 | manganese | + + | + + | + + | + + |
| Example 5 | AZ91D | 12 | manganese | + | + + | + + | + + |
| Example 6 | AZ91D | 200 | zirconium | + + | + + | + + | + + |
| Example 7 | AM60B | 180 | manganese | + + | + + | + + | + + |
| Example 8 | AZ31C | 110 | manganese | + | + | + + | + + |
| Comp.Ex. 1 | AZ91D | 0 | manganese | x | • | + + | + |
| Comp.Ex. 2 | AM60B | 0 | manganese | • | x | + + | + |
| Comp.Ex. 3 | AZ31C | 0 | manganese | x | x | + + | • |
| Comp.Ex. 4 | AZ91D | 0 | zirconium | • | • | + + | + |
| Comp.Ex. 5 | AZ91D | 5 | manganese | • | • | + + | + + |
| Comp.Ex. 6 | AZ91D | 0 | manganese | • | • | + + | + + |

In Examples 1 through 8, a magnesium phosphate coating was formed at the same time that the surface of the magnesium alloy member was cleaned by the chemical etching process. As the results in Table 1 make clear, Examples 1 through 8 gave a corrosion resistance and paint film adherence superior than those in Comparative Examples 1 through 4 in which the chemical etching process was omitted. In Comparative Example 5, the deposition of the magnesium phosphate coating was less than the specified amount, and in this case, satisfactory properties were not obtained. Satisfactory properties were also not obtained in Comparative Example 6, which employed sulfuric acid in the chemical etching process.

As has been described above, treatment of the surface of magnesium alloy members by the surface treatment method of the present invention produces a highly corrosion-resistant surface that have excellent paint adhesion. Since the inventive surface treatment method has the ability to induce the formation of a uniform, fine, and dense conversion coating even on chemically heterogeneous surfaces, it can produce stable properties that are resistant to the effects or influences of such factors as product shape, region on the product, and casting conditions.

The chemical etching bath used by this invention does not contain hexavalent chromium which may be harmful to humans and the environment and, assuming a so-called chromate agent is not used for the conversion treatment, will as a result have a very high commercial and industrial usefulness.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A surface treatment method for magnesium alloys comprising:
degreasing a surface of the magnesium alloy; chemically etching the surface of the magnesium alloy with an aqueous solution containing a phosphoric acid compound to form a magnesium phosphate coating having a coating weight of 10 to 2,000 mg/m², measured as phosphorus; and subjecting the magnesium alloy to a conversion treatment bath to form a conversion coating on the magnesium.

2. The method of claim 1 for the surface treatment of magnesium alloys, wherein the phosphoric acid compound in the phosphorous acid containing aqueous solution comprises at least 1 component selected from the group consisting of orthophosphoric acid, phosphonic acids, pyrophosphoric acid, tripolyphosphoric acid, and the alkali metal salts thereof, wherein the concentration of the phosphoric acid compound is in the range of 1 to 200 g/L and the pH of the aqueous solution containing a phosphoric acid compound is in the range of 1 to 12.

3. The method of claim 1 or 2 for the surface treatment of magnesium alloys, wherein the conversion treatment bath in the conversion treatment process comprises an acidic aqueous solution with a pH of 2 to 6 that contains at least orthophosphoric acid and at least 1 metal ion selected from the group consisting of Zn, Mn, and Ca.

4. The method of claim 1 or 2 for the surface treatment of magnesium alloys, wherein the conversion treatment bath in the conversion treatment process comprises an acidic aqueous solution with a pH of 2 to 6 that contains an oxoacid compound of at least 1 metal selected from the group consisting of Mn, Mo, W, Ta, Re, Nb, and V and at least 1 fluorine compound selected from the group consisting of hydrofluoric acid, fluosilicic acid, fluozirconic acid, and fluotitanic acid.

5. The method of claims 1 through 4 for the surface treatment of magnesium alloys, wherein the magnesium phosphate coating has a coating weight of 50 to 1,000 mg/m², measured as phosphorus.

6. The method of claim 1 through 5 for the surface treatment of magnesium alloys, wherein the pH of the aqueous solution containing a phosphoric acid compound is in the range of 1 to 10.

7. The method of claim 1 through 6 for the surface treatment of magnesium alloys, wherein the pH of the aqueous solution containing a phosphoric acid compound is in the range of 1 to 7.

8. A magnesium alloy member, as characteristically afforded by treatment of the surface of magnesium alloy by a surface treatment method as described in any of claims 1 through 7.

9. A liquid composition of matter suitable to treat the surface of magnesium alloys as described in any of claims 1 through 7.
